(19) United States
(12) Patent Application Publication
(10) Pub. No.: US 2009/0073232 A1
(43) Pub. Date: Mar. 19, 2009

(54) LIGHT IRRADIATOR AND A PRINTER USING THE LIGHT IRRADIATOR

(75) Inventors: Shigenori NAKATA, Yokohama-shi (JP); Katsuya WATANABE, Yokohama-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIODENKI KABUSHIKI KAISHA, Tokyo (JP)

(21) Appl. No.: 12/182,685

(22) Filed: Jul. 30, 2008

(30) Foreign Application Priority Data
Jul. 31, 2007 (JP) 2007-198841

(51) Int. Cl. B41J 2/14; F21S 2/00

(52) U.S. Cl. 347/51; 362/257

(57) ABSTRACT

To prevent clogging of a nozzle of a printing head, a light irradiator for an ink jet printer is composed of a short arc type discharge lamp (10) and optical elements used for linearly condensing light from the lamp (10), e.g., an elliptic light condensing mirror (20) and a rod lens (30) in order to linearly condense light emitted from the lamp onto a substrate (5). A slit-type light outlet (40) is provided on a bottom plate (60) of a housing (8) so that the direct light from the lamp cannot reach places on the substrate (5) in the vicinity of the nozzle (4) of a printing head (4), and antireflection material (70) is provided on the surface of the bottom plate (60) facing the substrate (5) so that the light emitted from the light irradiator and reflected by the substrate (5) can be absorbed by the antireflection material (70).

### BACKGROUND OF THE INVENTION

1. Field of Invention

The present invention relates to a light irradiator that allows forming a linearly thin and narrow light irradiation area using a short arc lamp and hardening photosetting liquid material discharged on a substrate by irradiating light and a printer that forms a pattern by discharging the photosetting liquid material on the substrate and using the light irradiator.

2. Description of Related Art

The ink jet printing method has widely been used in various printing fields including special printing, such as pictures, various types of printing, marking and color filters recently, because the gravure printing method allows forming images with ease and at a low price.

Specifically, the ink jet printing method allows providing high-quality images by combining an ink jet printer using the ink jet printing method that can discharge and control minute dots, ink improved in terms of color reproduction area, durability and discharge quality, and special-purpose paper markedly enhanced in terms of ink absorption, coloring of color material and surface luster.

The ink jet printers can be classified by the type of ink. Included is a photosetting ink jet method using a photosetting type ink that is hardened by irradiating light such as ultraviolet light. The photosetting ink jet method is very popular because it is relatively low odor and allows printing not only on special-purpose paper but also on printing media that dry quickly and do not absorb ink. In such an ink jet printer using the photosetting ink jet method (hereinafter referred to as “the ink jet printer”), not only a printing head used for discharging ink onto a substrate (a printing medium) in the form of minute droplets, but also a light source used for emitting light is loaded on a carriage, the carriage is moved while light is emitted on the printing medium, and the ink, right after being discharged on the printing medium, is hardened by irradiating light (see, Japanese Unexamined Patent Publication No. 2005-246955 corresponding to U.S. Pat. No. 7,316,476; Japanese Unexamined Patent Publication No. 2005-103852 and Japanese Unexamined Patent Publication No. 2005-305742).

The ink jet printer has recently been used to form an electric circuit pattern in addition to the aforementioned printing of images. In such a case, the liquid material discharged from the ink jet head is circuit board forming material such as photosetting type resist ink, and the substrate on which printing (i.e., the forming of a pattern) is performed is a printing board, for example. Like the printing of images, the forming of a circuit pattern by resist ink uses drying and hardening reaction with light, such as ultraviolet light. In both cases, the constitution of the ink jet printer is the same though the material discharged from the ink jet head is different (i.e., resist or ink).

A description of an ink jet printer for printing images on a substrate (a printing medium) using light (ultraviolet light)—setting ink is given below.

FIG. 12(a) is a perspective view showing the schematic constitution of the head part of an ink jet printer. FIG. 12(b) is a sectional view perpendicular to the optical axis of the light irradiators 6, 7 in FIG. 12(a). FIG. 12(a) is intentionally made transparent to make the description of the light irradiators easier below.

The ink jet printer 1 has a rod-shaped guide rail 2. On the guide rail 2 is held a carriage 3. The carriage 3 can be moved back and forth along the guide rail 2 on a substrate 5. Hereinafter, this direction is referred to as the X direction.

On the carriage 3 is loaded a printing head (an ink jet head) 4 provided with nozzles (not shown here) from which ink is discharged. On both sides of the printing head 4, along the moving direction of the carriage 3, there are the light irradiators 6, 7. The light irradiators 6, 7 irradiate light (ultraviolet light) to ink, the liquid material discharged to the substrate 5 from the nozzles of the printing head 4. The part constituted of the printing head 4 and the light irradiators 6 and 7 is hereinafter referred to as the head part 1a.

In FIG. 12, ink discharged from the printing jet head 4 of the head part 1a is hardened by light from the light irradiator 6 at a time when the carriage 3 is moving toward this side along the X direction to print on the substrate 5. Ink discharged from the printing head 4 is hardened by light from the light irradiator 7 at a time when the carriage 3 is moving toward the other side along the X direction to print on the substrate 5.

The light irradiators 6, 7 comprise a box-shaped cover member 8 having an opening 20 facing the substrate 5. Inside the cover member 8 is arranged a long arc type discharge lamp 90, a linear light source, along the direction at right angles to the moving direction (i.e., the X direction) of the carriage 3. The length of the illumination part of the lamp 90 is nearly equal to the length of the ink jet head 4 in the Y direction.

The long arc type discharge lamp includes a high-pressure mercury lamp and a metal halide lamp.

On the opposite side of the lamp 90 from the opening 20 is provided a trough-like reflector 110 for reflecting the light (ultraviolet light) emitted from the lamp 90. As shown in FIG. 12(b), the reflector 110 has an elliptical cross section. The discharge lamp is arranged on the first focal point of the reflector 110. The light (ultraviolet light) emitted from the lamp 90 is linearly condensed to the second focal point of the reflector 110. Here, the direct light from the lamp 90 is also irradiated.

FIG. 13 is an enlarged sectional view of the head part of the ink jet printer 1 in FIG. 12 perpendicular to the longitudinal direction of the lamp 90.

If a lamp is rod-shaped in a conventional light irradiator, the substrate 5 is irradiated not only by the light reflected from the trough-like reflector 110 but also by the direct light emitted from the lamp 90 as shown in FIG. 13.

Since the direct light from the lamp 90 spreads, the light outlets 40 of the light irradiators 6, 7 must be wide in the direction at right angles to the longitudinal direction of the lamp 90 (i.e. the moving direction of the head part 1a; the X direction) in order not to block the light so that the light from the lamp 90 can be used efficiently.

However, the wide light outlet 40 in the direction at right angles to the longitudinal direction of the lamp 90 allows the light from the light irradiator 6 (or 7) to reach places on the substrate in the vicinity of a nozzle of the printing head 4. As a result, the light reflected by the substrate 5 reaches the nozzle, and ink at or near the nozzle starts polymerization reaction such that the ink becomes more viscous and hardened. If the ink at or near the nozzle starts polymerization reaction such that the ink becomes more viscous and hardened, the nozzle changes in diameter, the amount of ink to be discharged tends to become inconsistent, and the nozzle is clogged as the case may be. As a result, there occurs a problem that it becomes difficult to form high definition images (patterns).

Moreover, the nozzle must be cleaned frequently in order to solve the aforementioned problem, resulting in a decline in a net working rate.

Japanese Unexamined Patent Publication No. 2006-159852 exemplifies the ink jet printing device designed to prevent light from irradiating places in the vicinity of a nozzle. The device this publication provides reflection plates in such a way that the reflected light of the ultraviolet light emitted from a light source becomes parallel light and the ultraviolet light is irradiated to a printing medium, wherein the reflection plate is inclined in such a way as to move away from a printing head as the reflected light approaches the printing medium, in order to decrease the amount of ultraviolet light that reaches a nozzle of the printing medium after being reflected or scattered by the printing medium as much as possible, wherein the ultraviolet light is emitted from the light source provided in the vicinity of the printing head.

As described above, conventional photosetting ink jet printers have a problem that light emitted from a light irradiator reaches places on a substrate in the vicinity of the nozzle of a printing head and then the light reflected by the substrate reaches the nozzle, resulting in more viscous or hardened ink.

The present invention is to solve the aforementioned problem. The object of the present invention is to allow forming high definition patterns by preventing the clogging of a nozzle, allow discharging ink for a long period stably and eliminate the necessity of frequent cleaning of the nozzle of a printing head.

### SUMMARY OF THE INVENTION

The present invention will solve the aforementioned problem as follows:

A light irradiator comprises a short arc type discharge lamp, optical elements to linearly condense the light emitted from the lamp and a slit-like light outlet corresponding to the shape of the linearly condensed light. Antireflection material is provided between the light outlet and a printing head.

The short arc type discharge lamp is a point light source and allows linearly condensing the light emitted from the lamp by properly combining optical elements such as mirrors and lenses.

Thus, if the light emitted from the lamp is linearly condensed using a light irradiator constituted of a short arc type discharge lamp and optical elements used for linearly condensing the light from the lamp, the light outlet of the light irradiator can be made narrow in the moving direction of the head part (i.e., in the X direction) without blocking the light from the lamp. In other words, the light outlet can be made slit-like thin corresponding to the shape of the light emitted from the lamp.

More specifically, in making the light outlet narrow in the X direction, bottom plates are provided on the light outlet side of the light irradiator, and a slit-like light outlet is formed on the bottom plates.

In addition, antireflection material is provided on the side of the bottom plates facing the substrate between the light outlet and the printing head.

The amount of light reaching the nozzle of the printing head can significantly be decreased by linearly condensing all the light emitted from the lamp, preventing the direct light from the lamp from reaching places on the substrate in the vicinity of the nozzle of the printing head, and, moreover, absorbing the light emitted from the light irradiator and reflected by the substrate using antireflection material.

In the present invention, a light irradiator is constructed of a short arc type discharge lamp and optical elements used for linearly condensing the light from the lamp. Accordingly, all the light emitted from the lamp is linearly condensed by the optical elements so that the direct light from the lamp cannot reach places on the substrate in the vicinity of the nozzle of the printing head. In addition, the light emitted from the light irradiator and reflected by the substrate is absorbed by antireflection material provided between the light outlet and the printing head.

Accordingly, the amount of light reaching the nozzle of the printing head can significantly be decreased.

Hence, it is possible to discharge ink for a long period stably, prevent the clogging of nozzles, and form high definition patterns.

Furthermore, the present invention can eliminate the necessity of cleaning nozzles frequently and prevent a decline in a net working rate of devices.

### BRIEF DESCRIPTION OF THE DRAWINGS

FIG. 1 shows the constitution of the light irradiator according to a first embodiment of the present invention.

FIG. 2 shows the constitution of an example without using a reflection mirror in FIG. 1.

FIG. 3 is a table that shows the results of measuring the irradiance of leaking light in the light irradiator according to the present invention and a conventional light irradiator.

FIGS. 4(a) & 4(b) are graphs showing the reflectance of matted aluminum and black alumite and the transmittance of a polyimide tape.

FIG. 5 shows the construction of the light irradiator according to the first embodiment applied to an ink jet printer.

FIG. 6(a)-6(c) show the construction of the light irradiator according to a second embodiment of the present invention from Z, Y & X axis directions, respectively.

FIG. 7 shows the construction of the light irradiator according to a third embodiment of the present invention.

FIG. 8 shows the construction of the light irradiator according to a fourth embodiment of the present invention.

FIG. 9(a) & 9(b) show the construction of the light irradiator according to a fifth embodiment of the present invention.

FIG. 10(a) & 10(b) show the construction of the light irradiator according to a sixth embodiment of the present invention.

FIG. 11(a) & 11(b) show the construction of the light irradiator according to a seventh embodiment of the present invention.

FIG. 12 is diagram showing the schematic construction of the head part of a conventional ink jet printer.

FIG. 13 An enlarged view of the head part of the ink jet printer in FIG. 12.

### DETAILED DESCRIPTION OF THE INVENTION

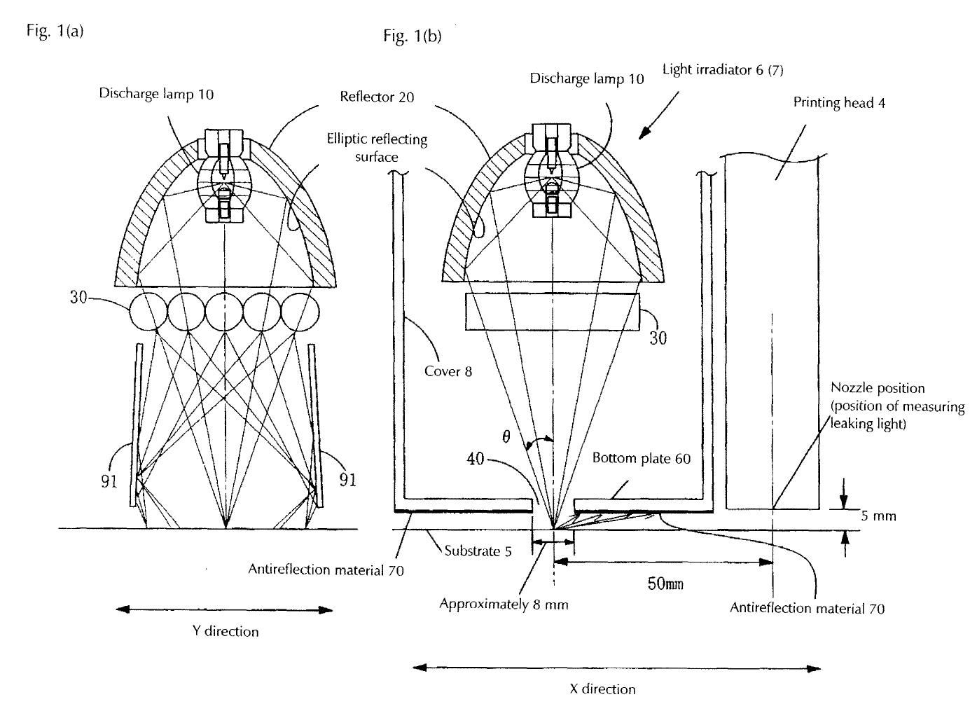

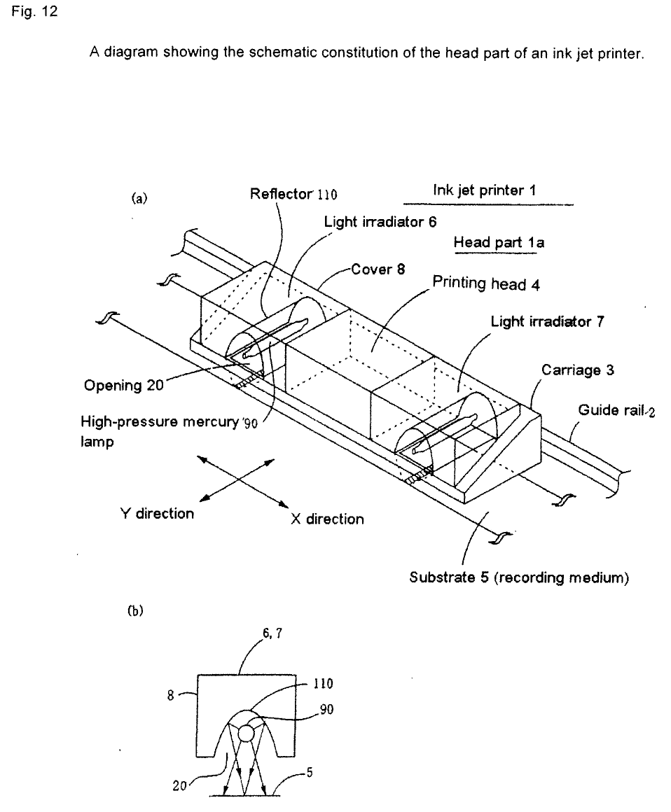

FIGS. 1(a) & 1(b) are enlarged views of the head part of the light irradiator according to the first embodiment of the present invention for use in a printer of the type shown in FIGS. 12(a) & 12(b). FIG. 1(a) is a sectional view in the Y direction (i.e., the direction at right angles to the moving direction of the head part). FIG. 1(b) is a sectional view of the X direction (i.e., the direction along the moving direction of the head part).

In FIGS. 1(a) & 1(b), the reference numeral 10 is a short arc type discharge lamp, which emits light of wavelengths that can harden liquid ink material discharged from the printing head 4. The reference numeral 20 is a reflector for reflecting and condensing the light from the lamp 10 and has a spheroidal reflecting surface.

The short arc type discharge lamp 10 is exemplified by an ultra high pressure mercury lamp that can efficiently emit ultraviolet light of 300 to 450 nm in wavelength, for example, wherein a pair of electrodes are arranged facing each other within a discharge vessel in such a way that the distance between the electrodes is in the range of 0.5 mm to 2.0 mm, for example, and wherein a specific amount each of mercury (light emitting material), rare gas (buffer gas for starting aid) and halogen is enclosed. The enclosed capacity of mercury is in the range of 0.08 to 0.30 mg/mm³, for example. The discharge lamp 10 is arranged in such a way that the line connecting the pair of electrodes extends along the optical axis of the reflector 20, and the light emitting part of the discharge lamp 10 (e.g., the arc spot) is arranged on the first focal point of the reflector 20 having a spheroidal reflecting surface.

The reference numeral 30 is a plurality of rod lenses, which are arranged in parallel, contacting each other on the plane perpendicular to the optical axis of the light reflected by the reflector 20 on the light outlet side of the reflector 20.

The light emitted from the lamp 10 is reflected by the spheroidal reflecting surface of the reflector 20 and is incident on the multiple rod lenses 30 as the light to be condensed to the second focal point of the reflector 20.

Of the light incident on the multiple rod lenses 30, the light in the direction at right angles to the longitudinal direction is condensed before the second focal point of the reflector 20 by the action of the rod lenses and spreads afterward. On the other hand, the light incident in the longitudinal direction is condensed on the second focal point of the reflector 20 because the rod lenses have no power in this direction.

Accordingly, the light linearly condensed in the direction at right angles to the longitudinal direction of the rod lenses 30 is obtained at the second focal point of the reflector 20 as shown in FIG. 1(b) and irradiates the substrate 5.

The light irradiator 6 (or 7) is covered with a housing 8 having a bottom plate 60 on the light outlet side. On the bottom plate is formed a slit-like light outlet 40 whose width is narrow in the X direction in correspondence with the shape of the linearly condensed light. The width of the light outlet 40 is approximately 8 mm, for example, in the X direction.

The bottom plate 60 is provided on the light irradiator 6 (or 7) for the following reason.

In principle, all the light emitted from the lamp 10 is reflected by the reflector 20 and linearly condensed on the substrate 5. In practice, however, stray light is generated by the reflection of light on the surface of a lens within a light irradiator. Supposing there is no bottom plate 60, chances are that unexpected places on the substrate 5 are irradiated by the stray light. The bottom plate is required in order to prevent the stray light from escaping from the light irradiator.

Antireflection material 70 is provided on the surface of the bottom plate facing the substrate 5 between the light outlet 40 and the printing head 4.

Antireflection material 70 includes surface processing such as the application of black paint and black alumite processing and pasting resin that absorbs light such as polyimide. It is desired that its reflectance is not more than 10%.

The linearly condensed light emitted from the light outlet 40 of the light irradiator 6 (or 7) irradiates the substrate 5. The light reflected by the substrate 5 moves toward the bottom plate 60 of the light irradiator 6 (or 7). However, since the aforementioned antireflection material is provided on the bottom plate 60, the light is not reflected there, but is absorbed instead by the antireflection material 70. Accordingly, the amount of light reaching the nozzle of the printing head 4 is extremely small. Although the antireflection material 70 may be provided only on the side of the printing head, it may be provided on both sides of the light outlet 40 as shown in FIG. 1.

FIG. 1(a) shows reflecting mirrors 91 on both sides of the multiple rod lenses 30 on the light emitting side arranged in order to reflect light spreading in directions at right angles to the axial direction of the rod lenses 30. Of the light incident on the rod lenses 30, light incident at right angles to the axial direction (longitudinal direction) is spread after being condensed by the rod lenses 30. Hence, the rays of light emitted from the rod lenses 30 overlap each other on the light irradiation surface with irradiance peaks that are different from each other so that the irradiance distribution becomes even in the light irradiation area, wherein the irradiance distribution is such that an irradiance value is high at the center area and low on the peripheral areas.

Therefore, the reflecting mirrors 91 are arranged on both sides of the multiple rod lenses 30 on the light emitting side in FIG. 1(a) in order to reflect light spreading in the direction at right angles to the axial direction of the rod lenses 30. (The reflecting mirrors 91 are not shown in FIG. 1(b))

Thus, by providing the reflecting mirrors 91 that reflect light spreading from the rod lenses 30, the length of the light irradiation area can be defined and a low irradiance value on the peripheral areas (end sections) can be supplemented.

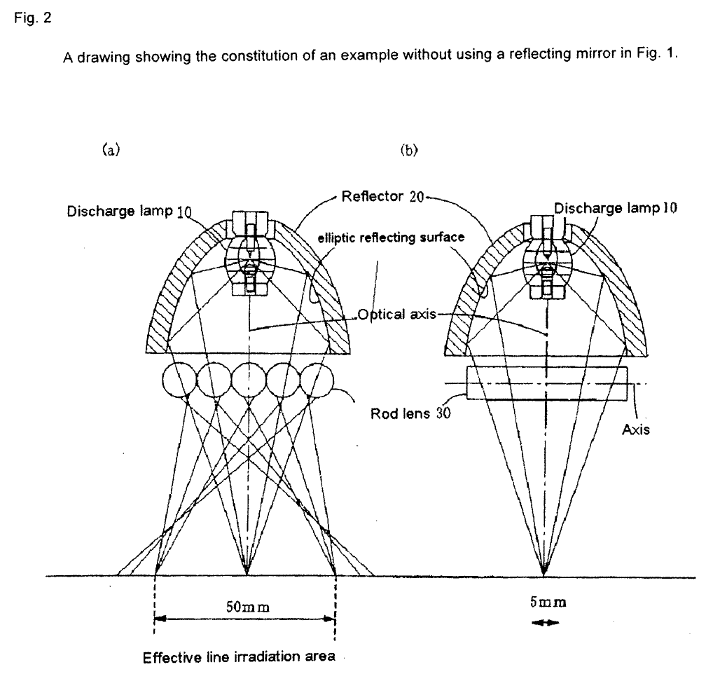

FIGS. 2(a) & 2(b) show the embodiment in FIG. 1 without reflecting mirrors. In FIG. 2, the housing is omitted.

In FIGS. 2(a) & 2(b), the light reflected by a reflector 20 is incident on rod lenses 30 as the light to be condensed on the second focal point of the reflector 20. Of the light incident on the rod lenses 30, the light along the axial direction is not influenced by the rod lenses 30, as shown in FIG. 2(b), and is condensed on the second focal point 2 of the elliptic reflector 20. On the other hand, the light in the direction at right angles to the axial direction spreads after being condensed by the rod lenses 30 to irradiate the light irradiation surface.

As a result, the linearly condensed light extended in the direction at right angles to the axial direction of the rod lenses 30 is obtained on the light irradiation surface. In FIG. 2, however, an irradiance distribution is such that an irradiance value is high at the center area and low on the peripheral areas because the reflecting mirrors 91 are not provided as shown in FIG. 1.

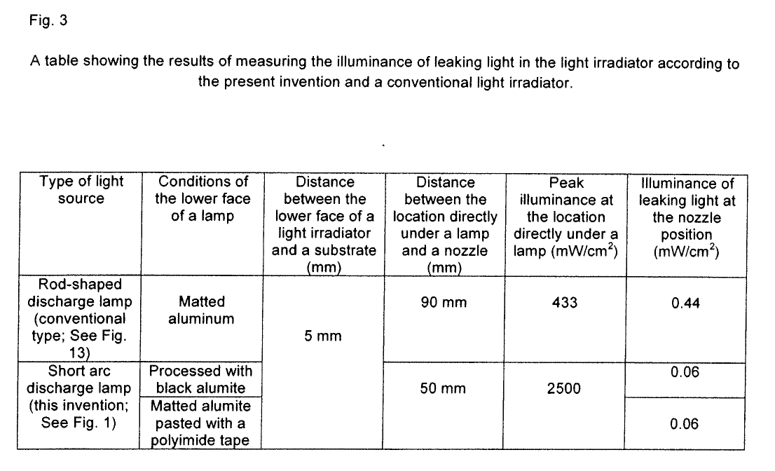

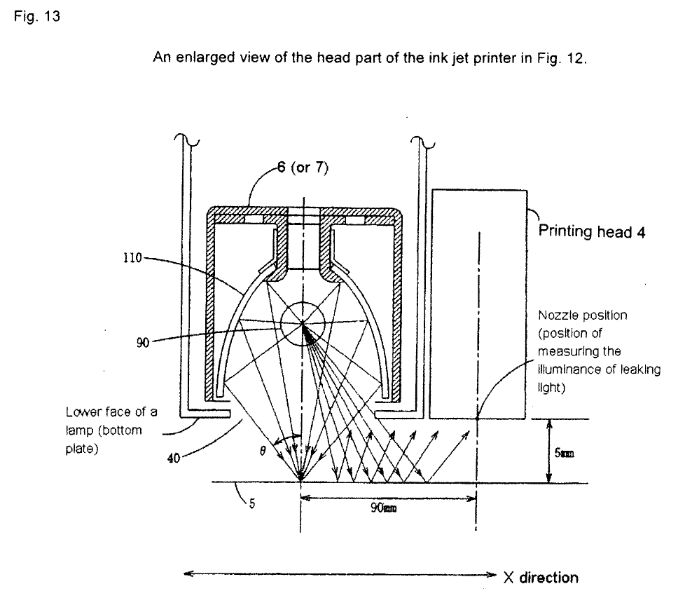

The present inventors measured light irradiance at a position where a nozzle of a printing head was supposed to be provided with light using the light irradiator according to the embodiment in FIGS. 1(a) & 1(b) and a conventional light irradiator as shown in FIG. 13. FIG. 3 shows the test results.

Specifically, in the light irradiator according to the embodiment in FIGS. 1(a) & 1(b), the photo detector of a UV irradiance meter was arranged at a position of approximately 50 mm right under a lamp with its receiving surface facing a substrate. In the conventional light irradiator as shown in FIG. 13, a photo detector was arranged at a position of approximately 90 mm. In both cases, the photo detectors had central sensitivity at 365 nm in wavelength.

In both light irradiators as shown in FIGS. 1(a) & 1(b) and FIG. 13, the distance between the under surface of the light irradiator and the substrate was 5 mm, and the material was matted aluminum plates.

The light irradiance measured by the photo detectors corresponds to the irradiance of the light reaching a nozzle of a printing head after being reflected by the substrate. In the table, the term “leaking light” is used for convenience's sake.

As shown in Table 3, in the conventional light irradiation device as shown in FIG. 13, the irradiance of leaking light was 0.44 mW/cm² at the position of a nozzle, while the peak irradiance right under a lamp was 433 mW/cm². The material used on the under surface of the lamp was matted alumite.

On the other hand, in the light irradiator according to the present invention as shown in FIG. 1, which was constituted of a short arc type discharge lamp 10 and optical elements used for linearly condensing light emitted from the lamp 10 and was provided with an aluminum bottom plate 60 having a slit-like light outlet in accordance with the shape of the linearly condensed light on the light outlet side of the light illuminator, wherein the surface of the bottom plate facing the substrate between the light outlet 40 and the printing head was made black by black alumite as antireflection material 70, the irradiance of leaking light was 0.06 mW/cm² at the position of a nozzle, while the peak irradiance right under a lamp was 2500 mW/cm².

Furthermore, a polyimide tape that absorbs ultraviolet light was pasted on the surface of a matted aluminum bottom plate as antireflection material 70 instead of the black alumite processing. Like the black alumite processing, the irradiance of leaking light was 0.06 mW/cm² at the position of a nozzle.

In the present invention, the peak irradiance right under a lamp was approximately five times as much peak iluminance as the conventional device. Also, the irradiance of leaking light was extremely small though the distance between the location right under the lamp and the nozzle (i.e., the place where the irradiance meter was arranged) was smaller.

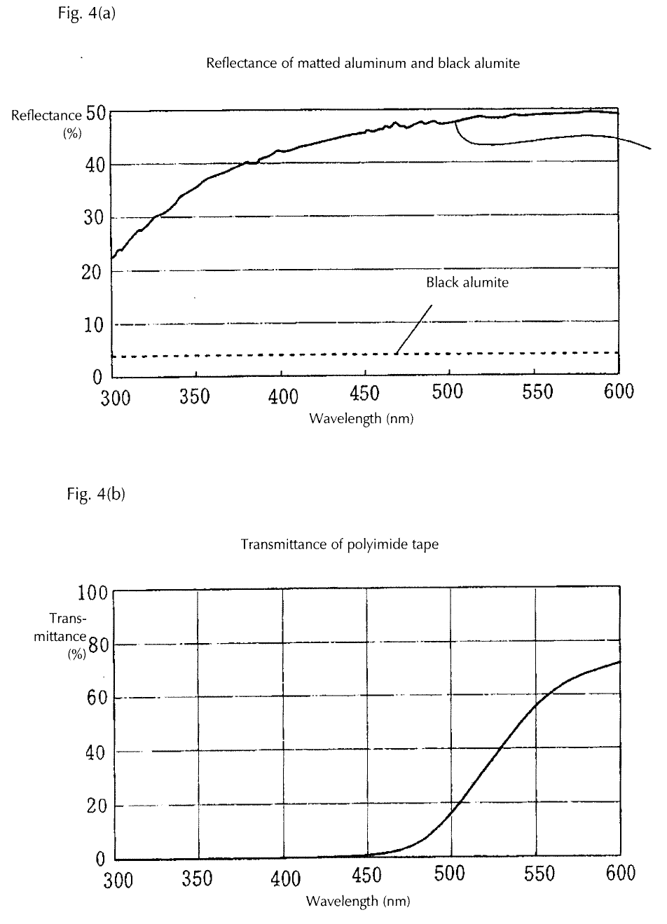

FIGS. 4(a) & 4(b) show the reflectance of matted aluminum and black alumite. FIG. 4(b) shows the transmittance of a polyimide tape. In FIGS. 4(a) & 4(b), the X-axis shows wavelength and the Y-axis shows reflectance in 4(a) and transmittance in 4(b). In general, energy beams hardenable resin for paint used for photosetting ink absorbs light of 250 nm to 400 nm in wavelength to be hardened. It is therefore desirable to use antireflection material that can at least prevent light of not more than 400 nm in wavelength from reflecting. Also, transmissive material, such as polyimide tapes, used in place of antireflection material desirably at least absorbs light of not more than 400 nm in wavelength.

As shown in FIG. 4(a), the reflectance of black alumite was approximately 5% at the wavelength of not more than 450 nm, while the reflectance of matted aluminum was approximately 45% at 450 nm in wavelength. Thus, the provision of black alumite on the bottom plate 60 as antireflection material 70 prevented light of at least 450 nm in wavelength from reflecting on the bottom plate and significantly decreasing the amount of light reaching the nozzle of the printing head.

Furthermore, the transmittance of the polyimide tape was nearly zero at 450 nm or shorter in wavelength as shown in FIG. 4(b). Thus, pasting a polyimide tape on the surface of the bottom plate 60 facing the substrate also prevented light of less than 450 nm in wavelength from reflecting and significantly decreasing the amount of light reaching the nozzle of the printing head.

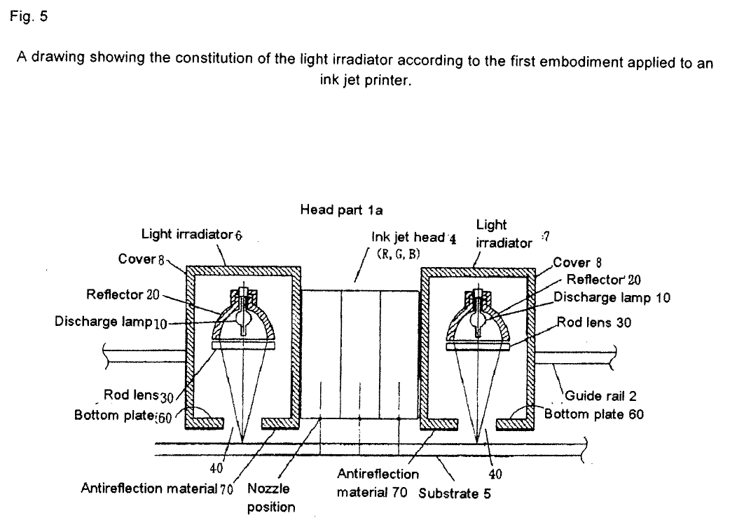

FIG. 5 is a sectional view showing the construction of the head part of the ink jet printer according to the present embodiment of the present invention.

This ink jet printer comprises an ink jet head 4 composed of heads such as R, G and B provided with nozzles (not shown here) through which minute droplets of photosetting ink (e.g., ultraviolet light-setting ink) are discharged onto a substrate 5 and a head part la provided with two light irradiator 6, 7 on both sides of the ink jet head 4 to be used for hardening the ink discharged on the substrate 5 by irradiating light in a specific wavelength range (e.g. ultraviolet light).

A carriage (not shown here) provided with the head part 1a is supported by a rod-shaped guide rail 2 provided in such a way as to extend along the substrate 5 and can be moved back and force (i.e., in the right and left directions in the drawing) above the substrate along the guide rail 2 by a drive mechanism of known construction (not shown).

The ultraviolet light-setting type ink to be used may be radical polymerization type ink containing radical polymerizable compounds as polymerizable compounds and cationic polymerizable compounds as polymerizable compounds. If the ink jet printer is used for forming patterns such as circuit boards, liquid material to be discharged from the ink jet head may be resist ink containing photo polymerizable compounds. The substrate 5 may be paper, resin, films, printed circuit boards and the like.

In this embodiment, the light irradiators 6, 7 are constructed in the same way as those in the first embodiment (See, FIG. 1).

That is, the light irradiators 6, 7 comprise a reflector 20 having the spheroidal reflecting surface, a discharge lamp 10, wherein the light emitting part (e.g., the arc spot) is arranged on the first focal point of the reflector 20 and the axis connecting electrodes is placed along the optical axis of the reflector 20, and rod lenses 30. The light source part is housed inside a housing 8 provided with a light outlet 40, and the surface of the bottom plate 60 of the housing 8 facing the substrate is provided with antireflection material 70.

The rod lenses 30 are arranged in such a way that its axial direction (i.e. the longitudinal direction) agrees with the direction of the arrangement of the light source part 10. On the substrate 5 is formed a linear light irradiation area in the direction at right angles to the axis of the rod lenses (i.e., the direction perpendicular to the paper surface).

The head part la of the ink jet printer according to this embodiment is arranged in such a way that the substrate 5 is positioned on or in the vicinity of the second focal point of the reflectors of the light irradiators 6 and 7 and is moved above the substrate 5 with the discharge lamp 10 turned on. Subsequently, the light emitted from the discharge lamp 10 impacts on the substrate 5 in such a way as to be linearly condensed in the direction at right angles to the moving direction of the head part (i.e., the direction perpendicular to the paper surface), whereby the ultraviolet light-setting type ink is hardened immediately after the impact on the substrate 5.

A description of the hardening processing of the ultraviolet light-setting type ink is given below more specifically. In FIG. 5, if the substrate 5 is being printed while the head part 1a is moving in the right direction, the ultraviolet light-setting type ink impacted on the substrate 5 is hardened by the light emitted from the light irradiator 6 positioned on the rear side of the moving direction of the head part 1a.

On the other hand, if the substrate 5 is being printed while the head part 1a is moving in the left direction, the ultraviolet light-setting type ink impacted on the substrate 5 is hardened by the light emitted from the light irradiator 7 positioned on the rear side of the moving direction of the head part 1a.

In the aforementioned embodiment, the light irradiators are comprised of the reflector 20 having the spheroidal reflecting surface, the discharge lamp 10 and the rod lenses 30. In addition, the following construction is also possible that uses a short arc type discharge lamp as a light source lamp and optical elements for linearly condensing the light emitted form the lamp.

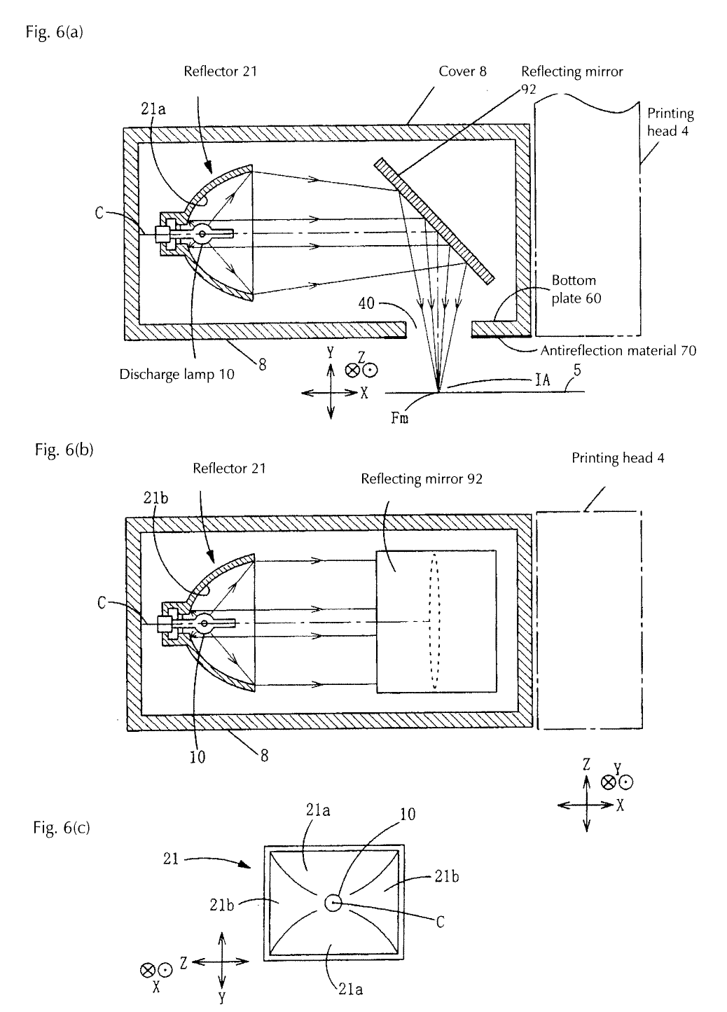

FIGS. 6(a)-6(c) show the construction of the light irradiator according to a second embodiment of the present invention comprising a short arc type discharge lamp, a reflector having the function of linearly condensing light and a plane reflecting mirror.

In the three-dimensional orthogonal coordinate system in which the optical axis of the reflector is the X-axis, the axis perpendicular to the substrate 5 and at right angles to the X-axis is the Y-axis, and the axis perpendicular to the Y-axis is the Z-axis, FIGS. 6(a) &b 6(b) are sectional views of the light irradiator taken on the surface passing through the optical axis C and in parallel to the X-Y plane and the surface passing through the optical axis C and in parallel to the X-Z plane, respectively. FIG. 6(c) shows the reflector 21 as seen from the light outlet side.

This embodiment has the shape of the reflector 21, which is provided in such a way as to enclose the short arc discharge lamp 10 and reflects the light emitted from the lamp, as shown below. Here, a reflecting mirror is a simple plane mirror only to bend an optical path.

As shown in FIG. 6(a), the shape of the section of the reflecting surface 21a taken by the X-Y plane is elliptic, and the construction is such that the light emitted from the lamp 10 is condensed on the substrate 5.

As shown in FIG. 6(b), the shape of the section of the reflecting surface 21b taken by the X-Z plane is parabolic, and the constitution is such that the light emitted from the lamp 10 becomes parallel rays.

The aforementioned shape of the reflector 21 allows condensing the light emitted from the lamp 10 on the substrate 5 as shown by IA in the drawing.

The light source part comprised of the lamp 10, the reflector 21 and the plane reflecting mirror 92 is housed inside a housing 8 provided with a light outlet 40, and the surface of the bottom plate 60 of the housing 8 facing the substrate is provided with antireflection material 70.

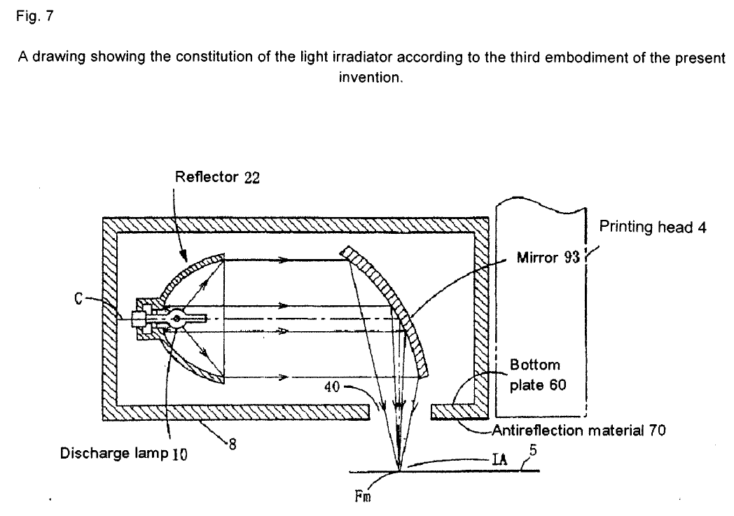

FIG. 7 shows the construction of the light irradiator according to a third embodiment of the present invention.

First, the light emitted form a short arc type discharge lamp 10 is reflected by a reflector 22 having the reflecting surface of a paraboloid of revolution and provided in such a way as to enclose a lamp 10. Next, the light reflected by the reflector 22 is reflected by a mirror 93 having a cylindrical reflecting surface whose section is parabolic only in a single axial direction.

In FIG. 7, the light emitted from the lamp 10 and reflected by the reflector 22 having the reflecting surface of a paraboloid of revolution are parallel rays. The parallel rays reflected by the mirror 93 having the cylindrical reflecting surface whose section is parabolic only in a single axial direction is linearly condensed on the light irradiation surface W in the direction perpendicular to the paper surface in FIG. 7.

As described above, the light source part comprised of the lamp 10, the reflector 22 and the mirror 93 is housed inside a housing 8 provided with a light outlet 40, and the surface of the bottom plate 60 of the housing 8 facing the substrate is provided with antireflection material 70.

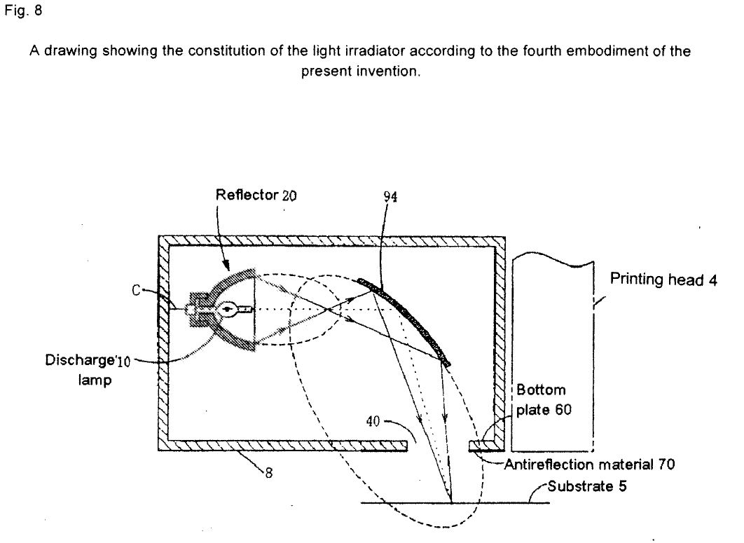

FIG. 8 shows the constitution of the light irradiator according to a fourth embodiment of the present invention.

First, the light emitted from a short arc type discharge lamp 10 is reflected by a reflector 20 having the spheroidal reflecting surface that functions as an elliptic light condensing mirror. Next, the light reflected by the reflector 20 is reflected by a mirror 94 having a cylindrical reflecting surface whose section is elliptic only in a single axial direction.

In FIG. 8, the light emitted from the lamp 10 is condensed after being reflected by the reflector 20 having the spheroidal reflecting surface. The light spreading after the condensation is reflected by the mirror 94 having the reflecting surface whose section is elliptic only in a single axial direction. The light reflected by the mirror 94 is linearly condensed on the light irradiation surface W in the direction perpendicular to the paper surface in FIG. 8.

As described above, the light source part comprised of the lamp 10, the reflector 20 and the mirror 94 is housed inside a housing 8 provided with a light outlet 40, and the surface of the bottom plate 60 of the housing 8 facing the substrate is provided with antireflection material 70.

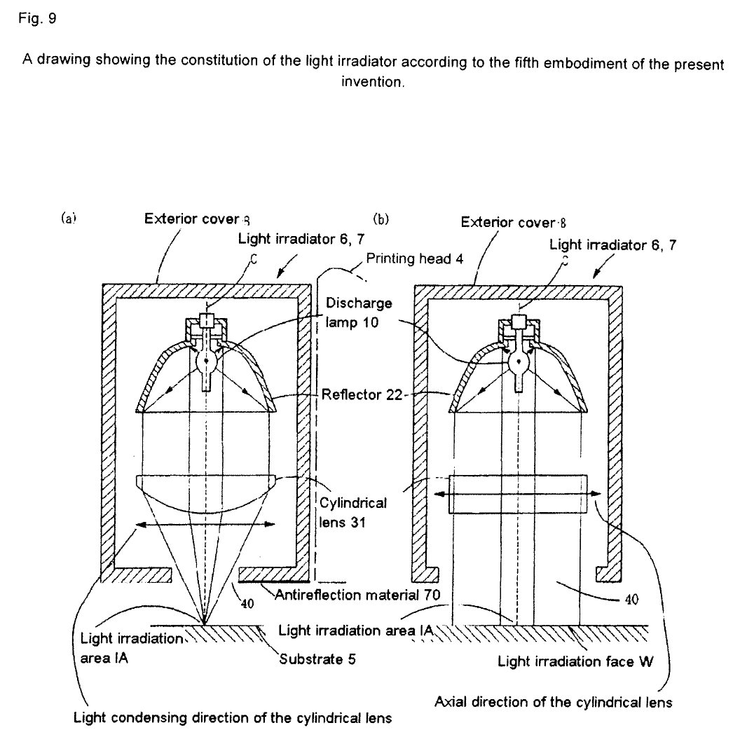

FIGS. 9(a) & 9(b) show the constitution of the light irradiator according to a fifth embodiment of the present invention. FIG. 9(a) is a sectional view taken by a plane along the moving direction of the head part. FIG. 9(b) is a sectional view taken by a plane at right angles to the moving direction of the head part.

The light emitted from a short arc type discharge lamp 10 is reflected by a reflector 22 having the reflecting surface of a paraboloid of revolution and then linearly condensed by a cylindrical lens 31 that condenses light only in the single axial direction.

In FIGS. 9(a) & 9(b), the light emitted from the discharge lamp 10 is reflected by the reflector 22 having the reflecting surface of a paraboloid of revolution to become parallel rays, which is then directed towards the cylindrical lens 31. The parallel light incident on the cylindrical lens 31 is discharged through a light outlet 40 after being condensed only in the direction at right angles to the axial direction of the cylindrical lens 31 (i.e., without being condensed in the axial direction of the cylindrical lens 31). Thus, a light irradiation area IA is linearly formed in the axial direction of the cylindrical lens 31 at the focal point of the cylindrical lens 31.

As described above, the light source part comprised of the lamp 10, the reflector 22 and the mirror 94 is housed inside a housing 8 provided with a light outlet 40, and the surface of the bottom plate 60 of the housing 8 facing the substrate is provided with antireflection material 70.

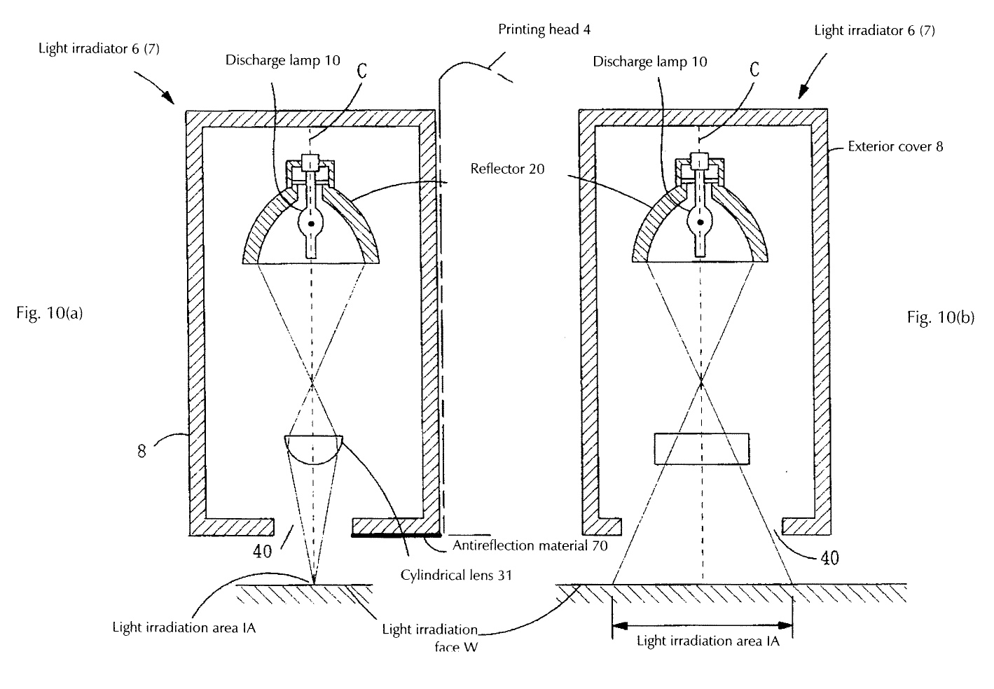

FIG. 10(a) & 10(b) show the constitution of the light irradiator according to a sixth embodiment of the present invention. FIG. 10(a) is a sectional view taken by a plane along the moving direction of the head part. FIG. 10(b) is a sectional view taken by a plane at right angles to the moving direction of the head part.

The light emitted from a short arc type discharge lamp 10 is reflected by a reflector 20 having a spheroidal reflecting surface that functions as an elliptic light condensing mirror and then linearly condensed by a cylindrical lens 31 that condenses light only in the single axial direction.

In FIGS. 10(a) & 10(b), the light emitted from the discharge lamp 10 is reflected by the reflector 20 having the spheroidal reflecting surface to be condensed on the second focal point of the spheroidal reflecting surface of the reflector 20. The condensed light is incident on the cylindrical lens 31 while spreading.

The light incident on the cylindrical lens 31 is discharged through a light outlet 40 after being condensed only in the direction at right angles to the axial direction of the cylindrical lens 31 while spreading in the axial direction of the cylindrical lens 31. Thus, a light irradiation area IA is linearly formed in the axial direction of the cylindrical lens 31 at the light condensing point of the cylindrical lens 31.

As described above, the light source part comprised of the lamp 10, the reflector 20 and the mirror 94 is housed inside a housing 8 provided with a light outlet 40, and the surface of the bottom plate 60 of the housing 8 facing the substrate is provided with antireflection material 70.

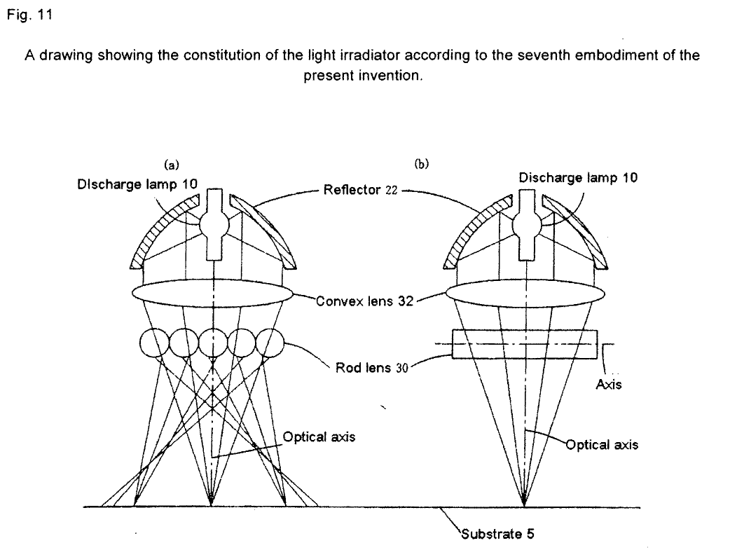

FIGS. 11(a) & 11(b) show the constitution of the light irradiator according to the seventh embodiment of the present invention. FIG. 11(a) is a sectional view taken along a plane extending along the moving direction of the head part. FIG. 11(b) is a sectional view taken along a plane at right angles to the moving direction of the head part. A housing 8, antireflection material 70 and the like are omitted in these figures.

The light emitted from a short arc type discharge lamp 10 is reflected by a reflector 22 having the reflecting surface of a paraboloid of revolution and then linearly condensed by a convex lens 32 and multiple rod lenses 30 arranged in parallel.

In FIG. 11, the light emitted from the discharge lamp 10 is reflected by the reflector 22 to become parallel rays. The parallel rays are incident on the convex lens 32 and then on the rod lenses as the light to be condensed at the focal point.

As described above, the rod lenses 30 condense and then spread light incident at right angles to the axial direction but has no influence on light incident in the axial direction. of the light incident on the rod lenses 30, the light incident in the axial direction is therefore condensed at the focal point of the convex lens 32 without being influenced by the rod lenses 30.

On the other hand, of the light incident on the rod lenses 30, the light incident at right angles to the axial direction is spread after being condensed by the rod lenses 30 to irradiate the light irradiation surface. Thus, linearly condensed light extending in the direction at right angles to the axial direction of the red lenses 30 is obtained on the light irradiation surface.

As described above (but not shown here), the light source part constituted of the lamp 10, the reflector 22, the convex lens 32 and the rod lenses 30 is housed inside a housing 8 provided with a light outlet 40, and the surface of the bottom plate 60 of the housing 8 facing the substrate is provided with antireflection material 70.

What is claimed is:

1. A light irradiator used in a printer, said printer comprising a printing head for discharging photosetting liquid material on a substrate and a head part having said light irradiator for irradiating light to harden the liquid material discharged on said substrate in order to form a pattern by hardening the liquid material by discharging the liquid material from the printing head to the substrate while moving the head part and the substrate relatively and then irradiating light on the liquid material discharged on the substrate by said light irradiator, said light irradiator comprising:
a short arc type discharge lamp having a pair of electrodes arranged facing each other in a discharge vessel,
optical elements for linearly condensing light emitted from said lamp and
a cover member having a slit-like light outlet through which said linearly condensed light exits, and
an antireflection material provided at a downstream side of said cover member for blocking reflection of light used for hardening said liquid material.

2. The light irradiator according to claim 1, wherein said cover member is a bottom wall of a housing enclosing said discharge lamp and said optical elements.

3. The light irradiator according to claim 2, wherein said optical elements comprise a reflector for reflecting and condensing the light from the lamp and one of a mirror and at least one lens.

4. The light irradiator according to claim 3, wherein said one of a mirror and at least one lens comprises a plurality of rod lenses arranged in parallel, contacting each other on a plane perpendicular to an optical axis of light reflected by the reflector on a light outlet side of the reflector.

5. The light irradiator according to claim 3, wherein said one of a mirror and at least one lens comprises a mirror disposed between the reflector and the outlet slit.

6. A printer comprising:
a printing head which is movable relative to the substrate for discharging photosetting liquid material onto the substrate to form a pattern on the substrate during relative movement of the head part with respect to the substrate,
a head part having a light irradiator for irradiating light toward said substrate for hardening the liquid material discharged onto said substrate for hardening the liquid material discharged from the printing head,
wherein said light irradiator comprises:
a short arc type discharge lamp having a pair of electrodes arranged facing each other in a discharge vessel,
optical elements for linearly condensing light emitted from said lamp,
a cover member having a slit-like light outlet from which said linearly condensed light exits, and
an antireflection material provided at a downstream side of said cover member for blocking reflection of light used for hardening said liquid material.

7. The light irradiator according to claim 6, wherein said cover member is a bottom wall of a housing enclosing said discharge lamp and said optical elements.

8. The light irradiator according to claim 7, wherein said optical elements comprise a reflector for reflecting and condensing the light from the lamp and one of a mirror and at least one lens.

9. The light irradiator according to claim 8, wherein said one of a mirror and at least one lens comprises a plurality of rod lenses arranged in parallel, contacting each other on a plane perpendicular to an optical axis of light reflected by the reflector on a light outlet side of the reflector.

10. The light irradiator according to claim 8, wherein said one of a mirror and at least one lens comprises a mirror disposed between the reflector and the outlet slit.
